(19) United States
(12) Patent Application Publication
(10) Pub. No.: US 2022/0014667 A1
(43) Pub. Date: Jan. 13, 2022

(54) Mobile Features Takeover Method and System

(71) Applicant: Abraham Varon Weinryb, Waltham, MA (US)

(72) Inventor: Abraham Varon Weinryb, Waltham, MA (US)

(21) Appl. No.: 17/362,345

(22) Filed: Jun. 29, 2021

Related U.S. Application Data
(60) Provisional application No. 63/085,366, filed on Sep. 30, 2020.
(60) Provisional application No. 63/076,836, filed on Sep. 10, 2020.
(60) Provisional application No. 63/045,333, filed on Jun. 29, 2020.

(51) Int. Cl. H04N 5/232; H04M 1/02

(52) U.S. Cl. CPC H04N 5/23206; H04N 5/23296; H04M 2250/20; H04M 1/0264; H04N 5/2328

(57) ABSTRACT

The invention relates to an operational communication-over-the-internet method and system in which take-over operations which are implemented within a software application are being sent over the internet from a sending user using a device with said software application to a second user's mobile device, in order to perform specific actions relating to specific features of the second user's mobile device, resulting in the second user's mobile device being jointly operated by both users.

### CROSS REFERENCE TO RELATED APPLICATIONS

This application claims benefit of provisional application 63/085,366 filed on Sep. 30, 2020.

This application claims benefit of provisional application 63/076,836 filed on Sep. 10, 2020.

This application claims benefit of provisional application 63/045,333 filed on Jun. 29, 2020.

### FIELD OF THE INVENTION

The field of the invention relates to a method and system for interaction between two people, each using a computing device, over the internet. The invention introduces new and productive ways to remotely perform operations over the internet in a way that combines operations performed by said two people into an optimized, commonly-obtained, resulted product.

### BACKGROUND OF THE INVENTION

In my Provisional application named “Visit Via Taker Method and System”, U.S. 63/045,333 dated Jun. 29, 2020, a system and method of video streaming and of services via the internet is claimed. In my additional Provisional application named “Instant Ideograms Method and System”, U.S. 63/076,836 dated Sep. 10, 2020, an innovative and efficient way to transfer instructions over the internet, with a specific implementation relating to video streaming over the internet is claimed. U.S. 63/076,836 presents innovative ways to provide instructions over the internet to a person (Taker), so that said instructions will be implemented by said person as following: (a) a Visitor selects an Instant Ideogram; (b1) a Taker sees the Instant Ideogram appearing at the Taker's device or (b2) the Taker receives a digital voice alert stating the name of the selected Instant Ideogram. e.g. “Turn Left” or (b3) The Taker both sees the Instant Ideogram and hears the related digital voice command; and (c) The Taker performs the operation required by said Instant Ideogram. To summarize: A Visitor and a Taker According to U.S. 63/045,333; Suppose that using voice, chat, or using new Instant Ideograms methods as described in U.S. 63/076,836, the Visitor requests the Taker to perform an operation by providing Visitor's Instructions.

For the purpose of explaining the current invention, however, said Visitor's Instructions may be defined as belonging to one of two categories. One category refers to something the Taker is doing by himself such as stopping or turning to the left. The second category refers to Device Operations, meaning operations to be applied on the mobile device of the Taker. For example: Take a snapshot.

The conceptual quantum leap of a Taker-Visitor activity according to U.S. 63/045,333 can be enhanced and optimized if said Device Operations could be implemented directly by the Visitor without the intermediation of the Taker.

It is therefore an object of the present invention to provide new ways to combine operations performed by two remote people into an optimized, commonly obtained, resulted product.

It is therefore an object of the present invention to provide innovative ways for interaction between two people over the internet in a way that saves time, eliminates mistakes, overcomes misunderstanding, enhances productivity, increases the quality of the resulted product and increases the satisfaction levels of the people involved.

It is therefore a particular object of the present invention to provide innovative ways for a Visitor-Taker interaction, which ultimately lead to a better Video Product and to higher satisfaction rate of both the Visitor and the Taker.

### SUMMARY OF THE INVENTION

The invention relates to an operational communication-over-the-internet method and system in which Take-Over operations which are implemented within a software application are being sent over the internet from a sending user using a device with said software application to a second user's mobile device who is the holder of said mobile device, in order to perform specific actions relating to specific features of said second user's mobile device, resulting in said second user's mobile device being jointly operated by said second user and by said sending user.

Preferably. said Take-Over operations relate not only to built-in features of said mobile device but also to features which are available to said mobile device due to an external device connected to said mobile device.

Preferably. said Take-Over operations is the ability of said sending user to take a snapshot with the camera of said mobile device, and at the same time said second user may continuously shoot video with said mobile device's camera.

Preferably, said Take-Over operations performed by said sending user is controlling video shooting features such as optical zoom at said mobile device, while the holder of said mobile device is aiming said mobile device's camera to various locations, so said device holder's is deciding what video to shoot while said sending user decides which zoom levels to use for said video.

Preferably, said external device is a holder with a gimbal stabilizer that can automatically rotate the phone from a landscape position to a portrait position and vice versa using an electric actuator, so one of said Take-Over operations is rotating said mobile device by 90 degrees.

Preferably. said sending user is a Visitor and said second user is a Taker.

### BRIEF DESCRIPTION OF THE DRAWINGS

In the drawings:

FIG. 1 shows a flow diagram and a functions' list, illustrating a pseudo code sequence of operations required according to the invention.

FIG. 2A shows an example of the invention and highlights some of the unique features and advantages of the invention.

FIG. 2B shows some typical screens relating to FIG. 2A.

FIG. 3 shows an example of the invention in which an additional auxiliary device is being used in order to extend the scope of the invention's possible use-cases.

### DETAILED DESCRIPTION OF PREFERRED EMBODIMENTS

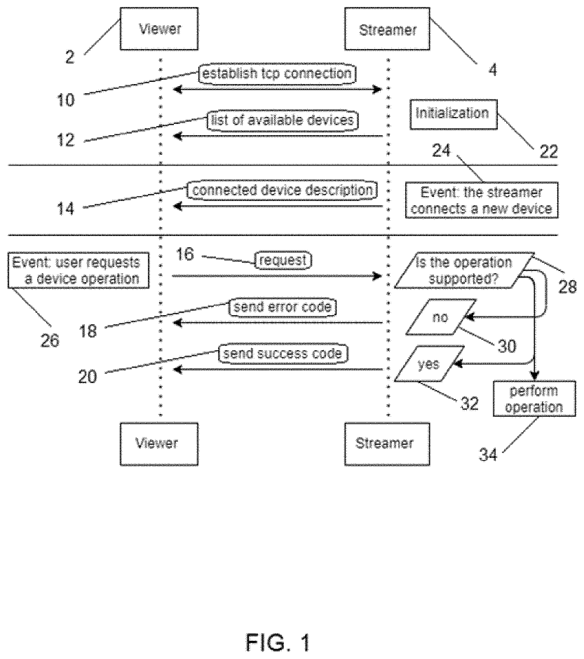

FIG. 1 illustrates two persons: A Viewer (2) and a Streamer (4). The Viewer may also be referred to as a Visitor, and the Streamer may also be referred to as a Taker, all according to the invention and with a reference to my U.S. 63/045,333 application which introduces a new concept of an active video streaming, in which the Taker who shots a video receives Visitor's Instructions from the Visitor who consumes the video. As mentioned before, Visitor's Instructions may be defined as belonging to one of two categories. One category refers to something the Taker needs to do by himself such as stopping or turning to the left. The second category refers to Device Operations, meaning operations to be applied on the mobile device of the Taker: for example, a snapshot. Another example: optical zoom. The purpose of this invention is to enable the Visitor to take over some of the functionality of the Taker's device and directly operate some of the functionality of the Taker's device, eliminating the need of intermediation by the Taker. In other words, the Visitor-Taker software application, according to the invention and with a reference to U.S. 63/045,333, will simply bypass the Taker and operates specific features of the Taker's device as a direct consequence to actions initialized by the Visitor.

The following is a typical description of functions, flow and the functionality according to the invention:

Startup (10):

Initially, The Viewer (Visitor) (2) in FIG. 1, and the Streamer (Taker) (4) are both starting the Visitor-Taker app and establishing an active TCP connection with the Visitor-Taker's Server, as described in U.S. 63/045,333. This startup process is illustrated at item (10) in FIG. 1.

Background Initialization Process (12)

Following said startup, the following background process is required: a preparation of a list of all in-built controllable devices in the Taker's mobile phone (22). This list is provided (12) to the Visitor-Taker app at the Visitor's side.

In addition to said in-built controllable devices, there also could be external devices connected to the Taker's device. For example: an external 360 camera. So, any external devices which are already connected to the Taker's phone will also be added to said list.

Event: The Taker Connects a New Device (24)

This relates to a situation in which, after Startup (10) and Initialization (22), sometime down the road, the Taker connects a new device. For example: a holder with a gimbal stabilizer that can automatically rotate the phone from a landscape position to a portrait position and vice versa, using an electric actuator. Whenever such new device is added, a function on_device_connected (device_id) will be called, and it will simply add (14) the new device to the devices' list of phase (12).

Event: The Taker Disconnects a Device (24)

This relates to a situation in which, after Startup (10) and Initialization (22), sometime down the road, the Taker disconnects a device. Whenever such new device is removed, a function on_device_disconnected (device_id) will be called. It will simply remove the new device from the devices' list of phase (12).

Event: TCP Controller—the Visitor Requests a Device Operation (26)

The Visitor, using the Visitor-Taker app, initiates a request that is translated to a specific device code plus a specific action code relating to said specific device. Such a request with a specific device code and an action code is transferred via the TCP connection (16) and received at the Taker's side. (In the Visitor-Taker's app, the TCP stream is contained in a special wrapper that automatically segments the stream into individual packets). When received at the Taker's side of the App, the code needs to determine if such operation (device code plus action code) is supported (28). One of three different scenarios can happen:

Scenario A. No connected device (either in-built or external) has the requested device code—item (30) at FIG. 1

Scenario B. A connected device matches the received device's code but it does not contain the required action code—also item (30) at FIG. 1

Scenario C. A device matching the received device's code is found and it also has the requested action code—item (32) at FIG. 1

In the cases of A and B, an error code will be sent back to the server (18), and the server will redirect the error code to the Visitor's side.

In the case of C, the Taker's device (the Taker's mobile phone, and in case of an involvement of an external device—the Taker's mobile phone Plus the external device) will perform the required action (34) and will send a success code to the server (20). The deliverables/consequences of such required actions will be delivered to the Visitor's side, of course.

There are many advantages to this invention:
(a) Split of work-load—this method results in a situation in which two persons (The Visitor and the Taker) are active in obtaining the resulted outcome. Two persons are more productive than one. It is harder for one person, the Taker, to walk; to look around; to get instructions from the Visitor; to take snapshots, if requested, while shooting a video at the same time; to zoom if requested; to respond to what he sees; and to respond to the visitor requests, all at the same time. According to the invention the work load is divided, and while the Taker does some things such as looking around, walking, keeping the mobile phone as stabilized a possible, and talking with the Visitor, the Visitor himself may do other things such as optical zoom at the Taker's device, taking directly some snapshots from the Taker's device, etc.
(b) Eliminate mistakes—whatever the Visitors does directly eliminates a possible mistake due to misunderstanding by the Taker or a Taker's error for whatever other reasons.
(c) Enhance productivity—simply because two people can do more than one at a given period of time. For example, one focuses on where to go and another focuses on when to zoom. More likely the Visitor will not miss interesting things along the route. The invention not only makes it easier for the Taker, but also increases the productivity of the Visit.
(d) Increase the quality of the resulted product—simply because each person has less things to do, so he can do such things better.
(e) Increase the accuracy of the resulted product. For example, the Visitor gets the exact snapshot desired because no extra time has been wasted in transferring the request for a snapshot via the Taker. The snapshot is being taken almost immediately, with a very small delay. The only delays in such case, according to the invention, relate to connection time and to device—controller's response. There is no human delay, as the Taker is excluded from the flow of the request which starts at the Visitor's mind and ends with an action executed by the Taker's device.
(f) As a result, increased satisfaction levels are expected by the Visitor, who gets high quality, fast and accurate deliverables and;
(g) Increased satisfaction levels are expected by the Taker, who both works less hard and gets a higher rate from the more-pleased Visitor.

The method of the invention will be farther explained and demonstrated hereby with examples.

### Example 1

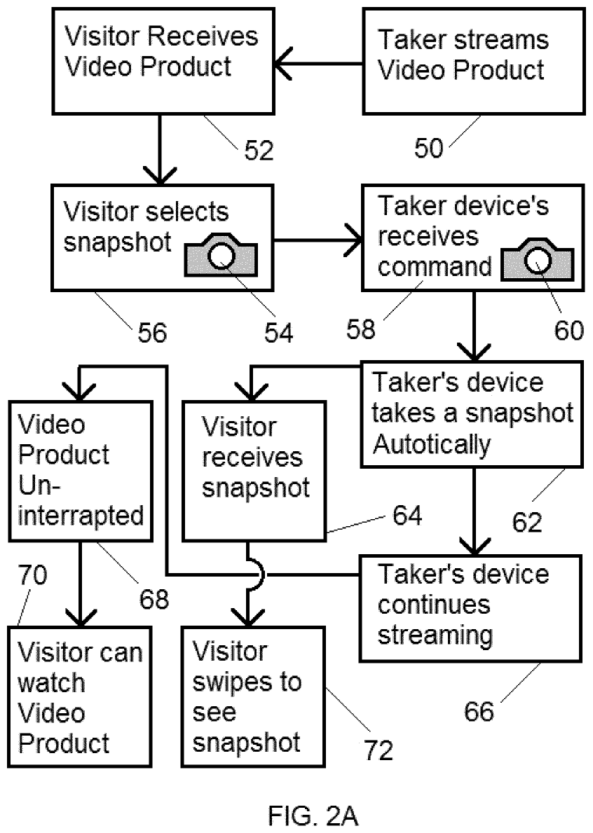

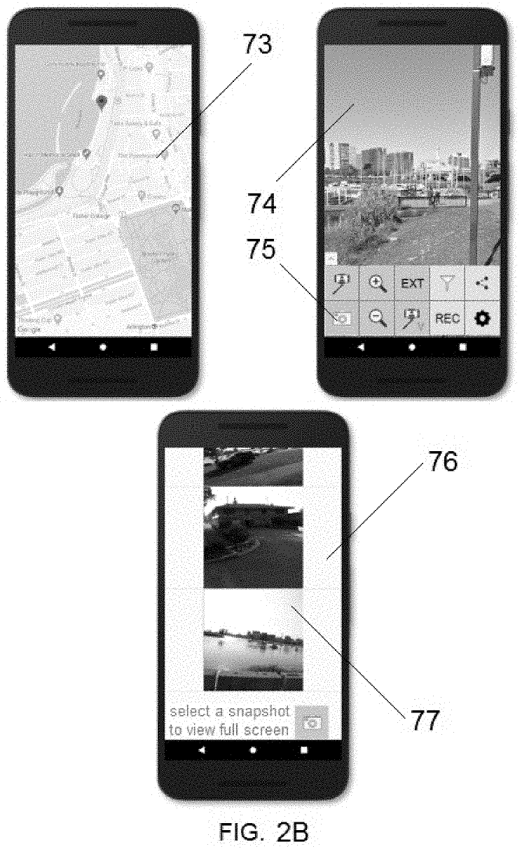

A Taker is streaming a video (50) in FIG. 2A, and a Visitor receives said video (52). At a given time, the Visitor's wants to take a snapshot of what he sees on the screen. The Taker at this point may be moving or standing still, all according to previously received instructions from the Visitor. The Visitor initiates (56) the desired snapshot by pressing a snapshot icon (53) at the Visitor-Taker app. Said app at the Taker's side receives the snapshot command (58), which includes the related device (camera) code and the related operation (snapshot) code. The Taker's mobile phone, automatically and without any involvement of the Taker, stops shooting the video for a moment, takes a snapshot (62), and then resumes taking a video (66). Optionally, a snapshot icon (60) appears for a moment at the screen of the Taker phone to inform the Taker that a snapshot has been taken, but said option (60) is an informative reference only that requires no operation whatsoever by the Taker, thus is optionally and not particularly important. The packets transferred via the TCP connection to the Visitor's device (the Visitor's phone, tablet or computer) include the taken snapshot (64). However, all the snapshot intervention according to the invention is so fast, typically, that the video streaming as receives at the Visitor's side (68) looks continuous and uninterrupted. Therefore the Visitor can continue watching such uninterrupted video (70), and, when desired, the Visitor can swipe the screen at the Visitor-Taker app in order to see (72) a list or large icons of all snapshots taken during the current Visit, including said last snapshot (56). The Visitor can select said large icon of said last snapshot to see it in full screen. When the Visitor swipes the screen to the opposite side, the screen returns to the streaming Video Product (70). FIG. 2B shows some typical screens at the Visitor's side relating to this example. While the Visitor's screen relates to a mobile phone in FIG. 2B, it could be as well a tablet screen or a screen of a computer's monitor. The Video Product as streamed by the Taker and sent to the Visitor is seen at the Visitor's screen (74) in FIG. 2B. The Visitor can swipe to the left in order to switch to a GPS map view (73) in which the Taker's location is seen. When the Visitor swipes back to the right, he returns to the Video Product's streaming (74). According to this example, when the Visitor selects the snapshot icon (75), the camera at the Taker's side takes a snapshot. If the Taker's camera is shooting a video, it will be interrupted for a moment in order to take the snapshot, but from the Visitor's side the video (74) is visually uninterrupted. Now, if the visitor swipes to right he sees the snapshots screen (76), in which the bottom Large Icon (77) shows the latest snapshot which has just been taken and sent to the Visitor. The snapshot, although taken by the Taker's device, is not saved at the Taker's device but only at the visitor's device. When the Visitor swipes back to the left he returns to the streaming Video Product (74) which is also saved at the Visitor's device, so the Visitor can, at any later time, view the Video Product as well as the snapshots taken.

### Example 2

Assume an external camera has a device code of 0x0AAB. Assume an operation code of 0x1FFB for invoking a night-vision mode of a camera and assume an operation code of 0x1FFF for using a wide lens of a camera.

Case I: If the Taker has no external camera and the Visitor sends the code for an external camera (0x0AAB), said scenario A will be triggered (30 at FIG. 1), and an error code will be sent back to the server (18 at FIG. 1), and the server will redirect the error code to the Visitor's side.

Cases II and III: If, on the other hand, the Taker's device is connected to an external camera, and such camera has a wide lens but does not have night vision, then:

Case II: If the Visitor sends the device code for an external camera (0x0AAB) and the operation code for a night vision mode (0x1FFB), said scenario B will be triggered (30 at FIG. 1), and an error code will be sent back to the server (18 at FIG. 1), and the server will redirect the error code to the Visitor's side.

Case III: If the Visitor sends the device code for an external camera (0x0AAB) and the operation code for a wide lens code instead (0x1FFF), case Scenario C will be triggered and the Taker's device will perform the required action (34 at FIG. 1) and will send a success code to the server (20 at FIG. 1).

### Example 3

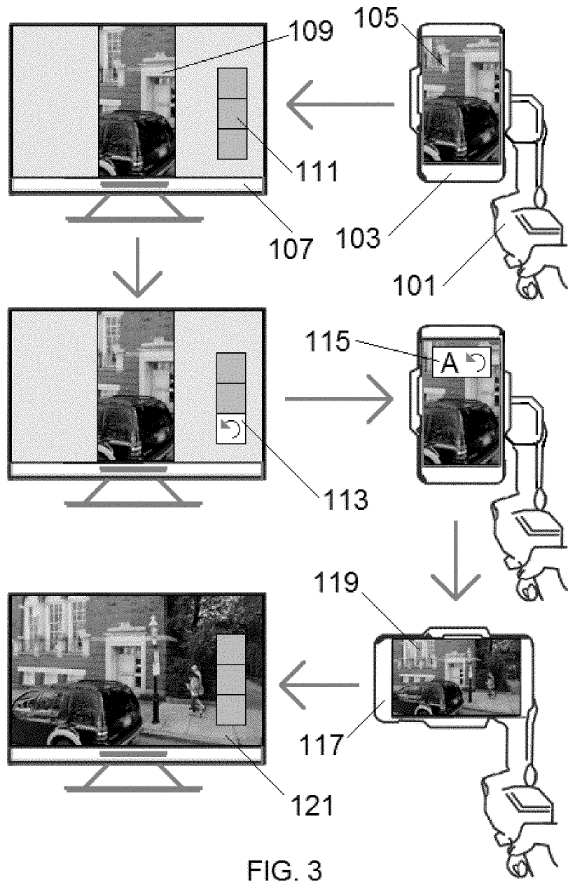

FIG. 3 shows a Taker's smartphone (103) mounted on a handle with a gimbal stabilizer (101) that can automatically rotate the phone from a landscape position to a portrait position and vice versa using an electric actuator. The initial position of the Taker's device (103) is portrait, and the Taker streams a video (105) to a Visitor who uses a computer and a computer's monitor (107) to view the Visit. The portrait video streaming is seen (109) on said monitor. Various Take-Over icons, according to the current invention and to U.S. 63/045,333, are displayed (111) within the Visitor-Taker app on the Visitor's side (the monitor).

One of said Take-Over icons shows a Rotate Arrow (113). This is the Take-Over icon that refers to automatically rotating the Taker's device by 90 degrees, assuming that an external device which supports such operation exists at the Taker's side. Once Take Over Icon (113) is pressed by the Visitor, a device code for external device (101), together with an operation code for a 90 degrees rotation is sent to the Taker-Visitor app at the Taker's side. Optionally, an informative display (115) appears, which includes in this example a letter “A” and a rotate arrow. When seen by the Taker, the Taker gets to know that an automatic 90 rotation operation has been performed by the Visitor.

At this point, and without any action whatsoever required from the Taker, the Taker's device is being rotated by the external device (101) and is now in a landscape position (117), thus streaming a video in landscape mode (119). The landscape video is streamed via the internet connection to the Visitor's monitor, thus it fills the entire screen of the monitor (121) and provides much more details. The entire process has been initiated and performed by the Visitor, using the Take-Over method of the current invention.

While some embodiments of the invention have been described by way of illustration, it will be apparent that the invention can be put into practice with many modifications, variations and adaptations, and with the use of numerous parameters that are within the scope of persons skilled in the art, without departing from the spirit of the invention or exceeding the scope of the claims.

1. An operational communication-over-the-internet method and system in which Take-Over operations which are implemented within a software application are being sent over the internet from a sending user using a device with said software application to a second user's mobile device who is the holder of said mobile device, in order to perform specific actions relating to specific features of said second user's mobile device, resulting in said second user's mobile device being jointly operated by said second user and by said sending user.

2. Method according to claim 1 in which said Take-Over operations relate not only to built-in features of said mobile device but also to features which are available to said mobile device due to an external device connected to said mobile device.

3. Method according to claim 1 in which one of said Take-Over operations is the ability of said sending user to take a snapshot with the camera of said mobile device, and at the same time said second user may continuously shoot video with said mobile device's camera.

4. Method according to claim 1 in which one of said Take-Over operations performed by said sending user is controlling video shooting features such as optical zoom at said mobile device, while the holder of said mobile device is aiming said mobile device's camera to various locations, so said device holder's is deciding what video to shoot while said sending user decides which zoom levels to use for said video.

5. Method according to claim 2 in which said external device is a holder with a gimbal stabilizer that can automatically rotate the phone from a landscape position to a portrait position and vice versa using an electric actuator, so one of said Take-Over operations is rotating said mobile device by 90 degrees.

6. Method according to claim 1 in which said sending user is a Visitor and said second user is a Taker.
